(19) United States
(12) Patent Application Publication
(10) Pub. No.: US 2018/0255972 A1
(43) Pub. Date: Sep. 13, 2018

(54) Grease and Debris Capturing System

(71) Applicant: Michele Delgado, Greensboro, NC (US)

(72) Inventor: Michele Delgado, Greensboro, NC (US)

(21) Appl. No.: 15/454,833

(22) Filed: Mar. 9, 2017

(51) Int. Cl. A47J 37/06

(52) U.S. Cl. CPC A47J 37/0664

(57) ABSTRACT

A grease and debris capturing system for inhibiting grease and debris from collection on a cooking appliance includes a range that has an oven and a stove top. The oven has a first heating element and the stove top has a plurality of second heating elements. A plurality of pans is provided and each of the pans is removably positioned beneath an associated one of the first heating element and the second heating elements. In this way each of the pans captures grease and debris resulting from cooking.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to capturing devices and more particularly pertains to a new capturing device for inhibiting grease and debris from collection on a cooking appliance.

### (h) BRIEF SUMMARY OF THE INVENTION

An embodiment of the disclosure meets the needs presented above by generally comprising a range that has an oven and a stove top. The oven has a first heating element and the stove top has a plurality of second heating elements. A plurality of pans is provided and each of the pans is removably positioned beneath an associated one of the first heating element and the second heating elements. In this way each of the pans captures grease and debris resulting from cooking.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a pan of a grease and debris capturing system according to an embodiment of the disclosure.

FIG. 2 is a bottom view of a pan of an embodiment of the disclosure.

FIG. 3 is a perspective phantom view of an embodiment of the disclosure.

FIG. 4 is a perspective in-use view of an embodiment of the disclosure.

### (j) DETAILED DESCRIPTION OF THE INVENTION

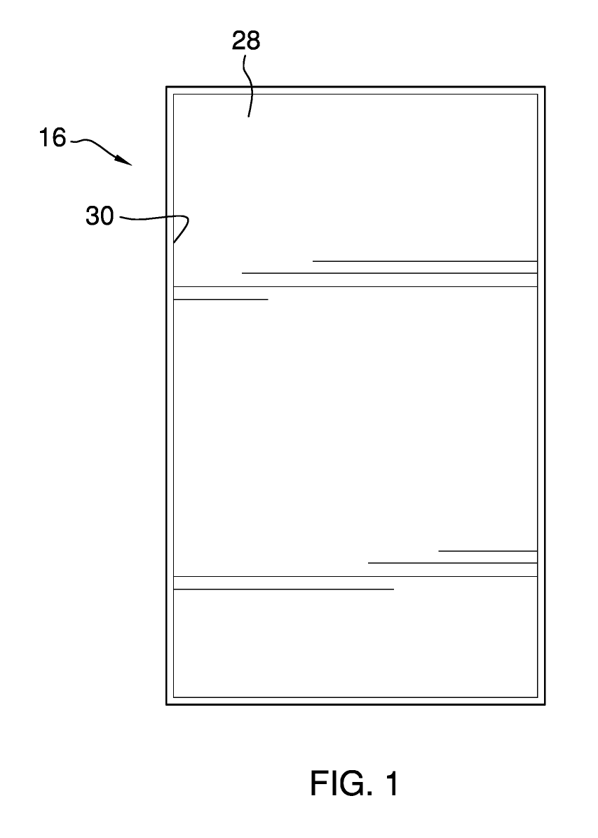

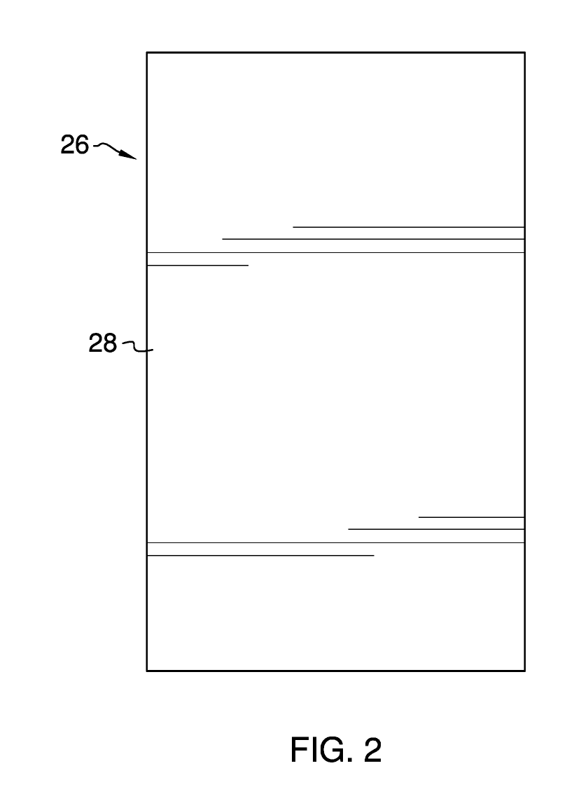

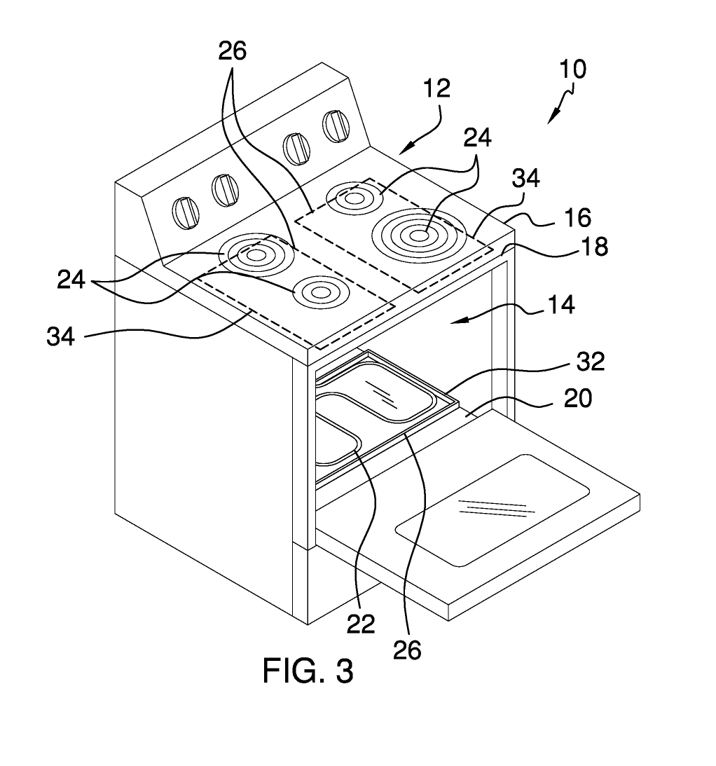

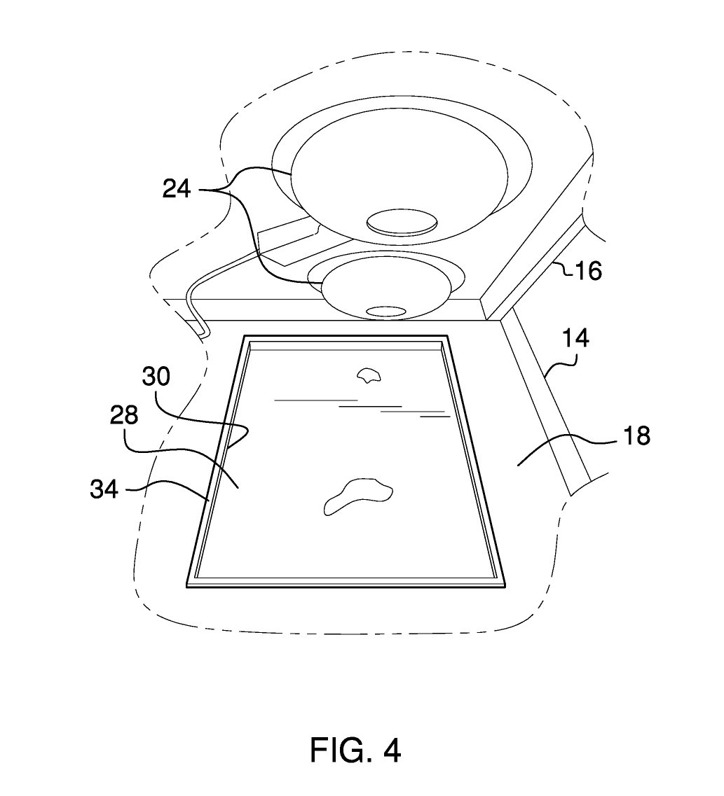

With reference now to the drawings, and in particular to FIGS. 1 through 4 thereof, a new capturing device embodying the principles and concepts of an embodiment of the disclosure and generally designated by the reference numeral 10 will be described.

As best illustrated in FIGS. 1 through 4, the grease and debris capturing system 10 generally comprises a range 12 that has an oven 14 and a stove top 16. The oven 14 has a top wall 18, a bottom wall 20 and a first heating element 22. The first heating element 22 is spaced from the bottom wall 20 and the stove top 16 is hingedly coupled to the top wall 18 of the oven 14. The stove top 16 has a plurality of second heating elements 24 positioned thereon. The range 12 may be an electric range, a gas range or any other conventional design thereof.

A plurality of pans 26 is provided and each of the pans 26 is removably positioned beneath an associated one of the first heating element 22 and the second heating elements 24. In this manner each of the pans 26 captures grease and debris resulting from cooking. Each of the pans 26 is comprised of a heat resistant material such as aluminum and silicon. Each of the pans 26 has a basal wall 28 and a perimeter wall 30 extending upwardly therefrom. The basal wall 28 captures the grease and debris and the perimeter wall 30 retains the grease and debris on the basal wall 28. Moreover, each of the pans 26 may have a width ranging between approximately 63.0 cm and 75.0 cm and a length ranging between approximately 88.0 cm and 100.0 cm.

The plurality of pans 26 includes an oven pan 32 and a set of stove top pans 34. The oven pan 32 is positioned on the bottom wall 20 and is positioned beneath the first heating element 22. In this way the oven pan 32 inhibits the grease and debris from collecting on the bottom wall 20. Thus, the oven pan 32 enhances keeping the bottom wall 20 of the oven 14 clean.

Each of the stove top pans 34 is positioned on the top wall 18 of the oven 14. Additionally, each of the stove top pans 34 is aligned with an associated one of the second heating elements 24. In this way each of the stove top pans 34 inhibits the grease and debris from collecting on the top wall 18. Thus, the each of the stove top pans 34 enhances keeping the top wall 18 of the oven 14 clean.

In use, the oven pan 32 is positioned on the bottom wall 20 of the oven 14 and the oven pan 32 is aligned with the first heating element 22. Thus, the oven pan 32 inhibits the grease and debris from collecting on the bottom wall 20 of the oven 14. The stove top 16 is urged into a lifted position and each of the stove top pans 34 is positioned on the top wall 18 of the oven 14. Each of the stove top pans 34 is positioned to be aligned within one of more of the second heating elements 24. The stove top 16 is positioned into a lowered position when each of the stove top pans 34 is positioned on the top wall 18. In this way each of the stove top pans 34 inhibits the grease and debris from collecting on the top wall 18 of the oven 14. The oven pan 32 and each of the stove top pans 34 are selectively removed for cleaning. Moreover, the oven pan 32 and each of the stove top pans 34 are selectively replaced with a new oven pan 32 and a new stove top 16 pan.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A grease and debris capturing system comprising:
a range having an oven and a stove top, said oven having a first heating element, said stove top having a plurality of second heating elements being positioned thereon; and
a plurality of pans, each of said pans being removably positioned beneath an associated one of said first heating element and said second heating elements wherein each of said pans is configured to capture grease and debris resulting from cooking.

2. The system according to claim 1, wherein said oven has a top wall, a bottom wall, said first heating element being spaced from said bottom wall, said stove top being hingedly coupled to said top wall of said oven.

3. The system according to claim 1, wherein each of said pans has a basal wall and a perimeter wall extending upwardly therefrom wherein said basal wall is configured to capture the grease and debris, wherein said perimeter wall is configured to retain the grease and debris on said basal wall.

4. The system according to claim 3, wherein:
said oven has a bottom wall; and
said plurality of pans includes an oven pan and a set of stove top pans, said oven pan being positioned on said bottom wall and being positioned beneath said first heating element wherein said oven pan is configured to inhibit the grease and debris from collecting on said bottom wall.

5. The system according to claim 4, wherein:
said oven has a top wall; and
each of said stove top pans is positioned on said top wall of said oven having each of said stove top pans being aligned with an associated one of said second heating elements wherein each of said stove top pans is configured to inhibit the grease and debris from collecting on said top wall.

6. A grease and debris capturing system comprising
a range having an oven and a stove top, said oven having a top wall, a bottom wall and a first heating element, said first heating element being spaced from said bottom wall, said stove top being hingedly coupled to said top wall of said oven, said stove top having a plurality of second heating elements being positioned thereon; and
a plurality of pans, each of said pans being removably positioned beneath an associated one of said first heating element and said second heating elements wherein each of said pans is configured to capture grease and debris resulting from cooking, each of said pans having a basal wall and a perimeter wall extending upwardly therefrom wherein said basal wall is configured to capture the grease and debris, wherein said perimeter wall is configured to retain the grease and debris on said basal wall, said plurality of pans including an oven pan and a set of stove top pans, said oven pan being positioned on said bottom wall and being positioned beneath said first heating element wherein said oven pan is configured to inhibit the grease and debris from collecting on said bottom wall, each of said stove top pans being positioned on said top wall of said oven having each of said stove top pans being aligned with an associated one of said second heating elements wherein each of said stove top pans is configured to inhibit the grease and debris from collecting on said top wall.
